(19) United States
(12) Patent Application Publication
(10) Pub. No.: US 2009/0110155 A1
(43) Pub. Date: Apr. 30, 2009

(54) Inactivity alarm

(76) Inventor: Stephen Graves, Rudy, AR (US)

Correspondence Address: LITMAN LAW OFFICES, LTD., POST OFFICE BOX 15035, CRYSTAL CITY STATION, ARLINGTON, VA, 22215-0035, US

(21) Appl. No.: 11/979,068

(22) Filed: Oct. 30, 2007

(51) Int. Cl. H04M 11/04; G08B 23/00

(52) U.S. Cl. 379/51; 340/527; 455/404.1

(57) ABSTRACT

The inactivity alarm has programmable interval timing electronic circuitry, including a reset button. Audible alert electronic circuitry is actuated by timeout of the programmable timing interval to provide successively louder audible signals if the reset button has not been pressed within the timing interval. In another embodiment, the system is included in an electronic telephone. The telephone sends a signal responsive to a predetermined user actuation of the phone. A first timer is resettable by the telephone signal to prevent timeout. The audible alert is activated by timeout of the first timer. A programmed telephone number dialing circuit and second timer are provided. The second timer is resettable by the telephone signal to prevent timeout of the second timer. The programmed telephone number dialing circuitry is activated on timeout of the second timer to dial at least one stored telephone number. Alternatively, timer functions are implemented in a Central Office.

### BACKGROUND OF THE INVENTION

1. Field of the Invention

The present invention relates generally to personal alarms, and more particularly to an inactivity alarm having an audible alarm that is activated if the user has not reset a timer within the time interval.

2. Description of the Related Art

In the course of medical practice many patients are encountered who are confined to home for extended periods of time and could at anytime become incapacitated from disease or accident. Such instances often result in the death of the person because his condition is not discovered at an early stage. Oftentimes, such persons are physically incapacitated due to a sudden attack or accident and are physically unable to actuate any source of warning or alarm device. Additionally, persons suffering from heart trouble, stroke, or diabetic complications may find themselves unable to physically actuate a warning device or alarm. Moreover, hunters, hikers, mountain-climbers and fishermen and others who go outside are at risk of being incapacitated due to unforeseen circumstances and would not be able to actuate a warning device or alarm without some automated assistance or intervention.

It would therefore be advantageous to provide a warning system, either standalone, or for use with an electronic telephone, that will automatically call a predetermined number or numbers in the event that an alarm is not reset by the user within a predetermined interval of time after the initiation of an alarm.

Thus, an inactivity alarm solving the aforementioned problems is desired.

### SUMMARY OF THE INVENTION

The inactivity alarm has programmable interval timing electronic circuitry, including a reset button. Audible alert electronic circuitry is actuated by timeout of the programmable timing interval to provide successively louder audible signals if the reset button has not been pressed within the timing interval. In another embodiment, the system is included in an electronic telephone. The telephone sends a signal responsive to a predetermined user actuation of the phone. A first timer measures a first timing interval that is resettable by the telephone signal to prevent timeout. The audible alert is activated by timeout of the first timing interval. A programmed telephone number dialing circuitry and second timer are provided. The second timer measures a second timing interval that is resettable by the telephone signal to prevent timeout of the second timing interval. The programmed telephone number dialing circuitry is activated on timeout of the second timing interval to dial at least one telephone number programmed therein. Alternatively, timer functions are implemented in a central office.

These and other features of the present invention will become readily apparent upon further review of the following specification and drawings.

### BRIEF DESCRIPTION OF THE DRAWINGS

FIG. 1 is a block diagram of a first embodiment of the inactivity alarm according to the present invention.

FIG. 2 is a block diagram of a second embodiment of an activity alarm according to the present invention.

FIG. 3 is a block diagram of a third embodiment of an activity alarm according to the present invention.

Similar reference characters denote corresponding features consistently throughout the attached drawings.

### DETAILED DESCRIPTION OF THE PREFERRED EMBODIMENTS

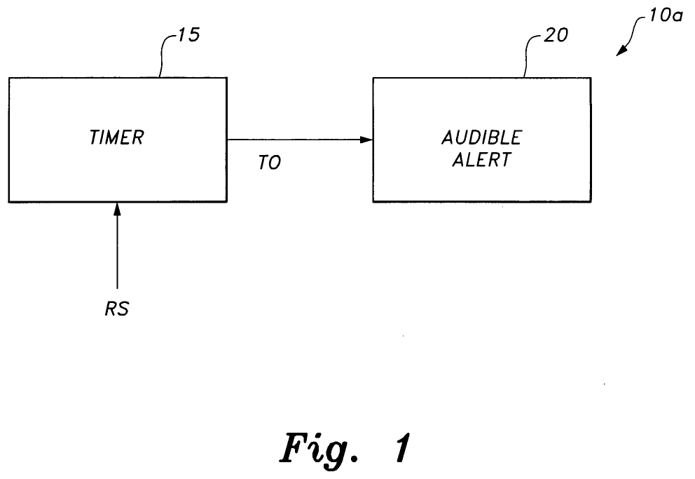

The present invention relates to an inactivity alarm. In a first embodiment, the inactivity alarm 10a, shown in FIG. 1, has programmable interval timing electronic circuitry 15 that is resettable by a reset signal RS. Timer 15 preferably has a timeout signal TO that is directed to energize audible alert 20. Reset signal RS may be actuated by a user through some interface means, such as a reset button or key, touch pad, sensor, or the like.

Audible alert electronic circuitry 20 is actuated by timeout of the programmable timing interval to provide successively louder audible signals if the reset signal RS has not been actuated within the timing interval. Once the timer 15 has timed out, the timeout signal TO is sent to the alert 20 and the alarm sequence begins. If the user responds by pressing a reset button or other interface to initiate reset signal RS, the timer is reset for a new counting sequence and the audible alert 20 is silenced.

The audible alert module 20 preferably sends groups of alert messages or tones that successively increase in volume. Audible alert electronic circuitry 20 may be programmed to start emitting a group of soft beeps repetitively over a predetermined time interval. Then the alert 20 may emit louder beeps until the unit 10a is reset. Preferably the system 10a is provided in a form that is wearable by the user or capable of being stored in a purse, pocket, or the like.

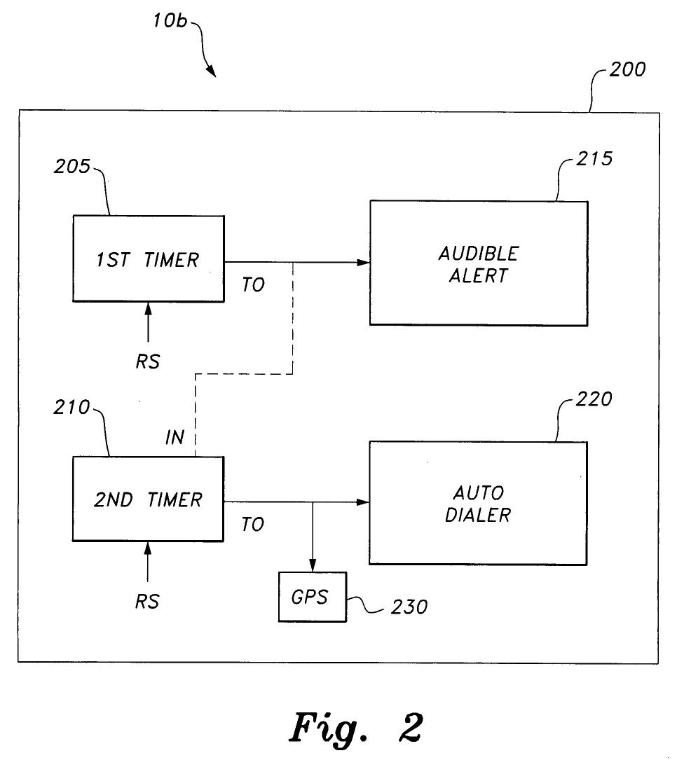

In another embodiment, shown in FIG. 2, inactivity alarm 10b is included in an electronic telephone 200. The telephone 200 sends a reset signal RS responsive to a predetermined user actuation of the phone 200. The predetermined user actuation may be user activity, such as sending any call within a predetermined time period, sending a specified call to a specified number within the predetermined time period, pressing a specified key, button or sequence of keys/buttons on the phone 200 within the predetermined time period, or otherwise interacting with the phone 200 in a specified manner within the predetermined time period.

The inactivity alarm 10b may be integrated within a cell phone, or attached to the cell phone via external interface connection, or similarly integrated or interfaced to a customer premise equipment (CPE) phone system connectable to wired line telephone system known to those having ordinary skill in the art as POTS.

Regardless of type of electronic phone 200, a first timer electronic circuitry 205 measures a first timing interval that is resettable by the telephone signal RS to prevent timeout. The audible alert electronic circuitry 215 is activated by timeout TO of the first timing interval. The audible alert module 20 preferably sends groups of alert messages or tones that successively increase in volume. Audible alert electronic circuitry 215 may be programmed to start emitting a group of soft beeps repetitively over a first predetermined alert time period. Then the alert 20 may emit louder beeps over a second predetermined alert time period, such as, 3-4 minutes or the like.

A programmed telephone number dialing circuitry 220 and second timer electronic circuitry 210 are provided. The second timer 210 measures a second timing interval that is resettable by the telephone signal RS to prevent timeout of the second timing interval. The programmed telephone number dialing circuitry 220 is activated on timeout TO of the second timing interval to dial at least one telephone number programmed in the dialing circuitry 220.

As shown in FIG. 2, the second timer 210 may be programmed independently from the first timer 205, or the second timer 210 may be initiated by timeout TO of the first timer 205. It should be understood that if the first timer 205 and second timer 210 run independent of each other, the second timer 210 should have a longer time interval than the time interval of the first timer 205. Thus, regardless of whether the timer 210 runs independent of timer 205, if the user fails to reset the timers 205, 210 while the audible alert is sounding, the programmed telephone number is dialed to alert a remote party such as a care-giver, family member, or the like to indicate inactivity of the user.

Moreover, the auto dialing circuitry 220 may be programmed to re-dial the programmed telephone number(s) for a predetermined number of rings (e.g., 2 to 3 rings) every predetermined re-dialing time period. Additionally, a GPS system 230 may be provided for assistance in finding the user, the GPS system 230 being activated in a coordinated manner with activation of auto dialer 220. Coordinated activation of the GPS system 230 means that the GPS system 230 is activated by the system 10b either contemporaneously with activation of the auto dialer 220 or proximate in time to the time of activation of the auto dialer 220.

It should be understood that reference in this document to electronic circuitry means digital, analog, any combination of digital and analog circuitry, including but not limited to arithmetic logic units (ALU), digital signal processors, (DSP), microprocessors, or the like. The timers and other functions shown in FIGS. 1-3 may be implemented in hardware, software, firmware, or any combination of the same.

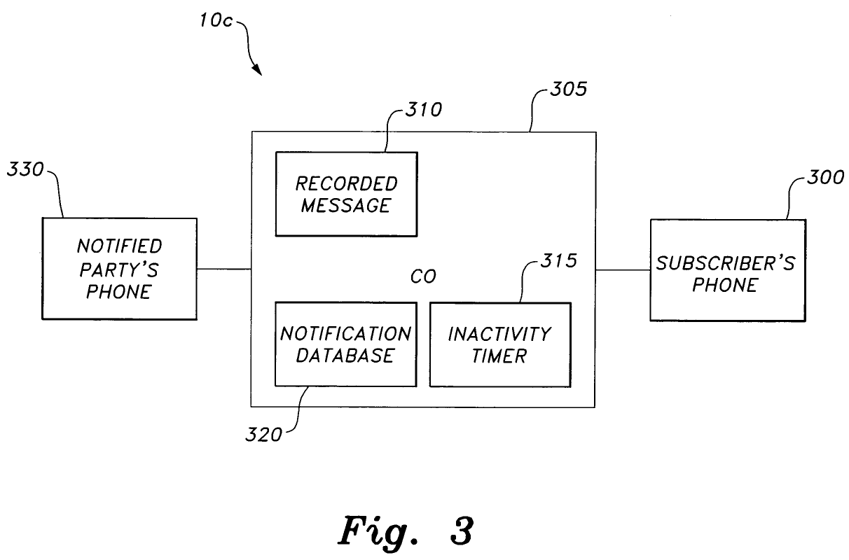

In another embodiment, shown in FIG. 3, inactivity alarm 10c is included in a service provider's electronic switch and/or central office (CO) equipment 305. Modern telephone service provider switching equipment can be programmed to log and store line usage, dialed numbers, received calls, missed calls, and the like.

In another embodiment, shown in FIG. 3, a telephone service provider's switch processing capability is used to implement a line inactivity timer 315 within the switch 305. The inactivity timing service may be programmed by the service provider as a paid service that the subscriber must pay for usage, or flat monthly fee, or combination thereof. The line inactivity timer 315 may be programmed to time intervals between calls dialed out, time intervals between received calls, or some combination of both dialed out and received call statuses.

A notification database 320 is provided and can store a plurality of contact numbers for inactivity alarm notification. A recorded message database 310 is provided and may store default or customized notification messages for each subscriber to the service. When the inactivity timer 315 has timed out, at least one of the subscriber's contact numbers is dialed, and, depending upon setup of the service, a standard message or customized message is retrieved from message database 310 and played to the contactee's telephone 330.

It is to be understood that the present invention is not limited to the embodiments described above, but encompasses any and all embodiments within the scope of the following claims.

I claim:

1. An inactivity alarm, comprising:
a programmable interval timing circuit having a reset button; and
an audible alert circuit actuated by timeout of a timing interval measured by the programmable interval timing electronic circuit for being activated to provide successively louder audible signals when the reset button has not been pressed within the timing interval.

2. The inactivity alarm according to claim 1, further comprising a housing adapted for being worn by a user, the interval timing circuit and the audible alert circuit being disposed in the housing.

3. The inactivity alarm according to claim 1, wherein the audible signals comprise a group of soft audible signals repeating over a predetermined time interval, the soft audible signals increasing in volume after expiration of the predetermined time interval.

4. An inactivity alarm, comprising:
an electronic telephone;
means for sending a signal from the telephone in response to a selected mode of user actuation of the phone;
a first programmable interval timing electronic circuit for measuring a first timing interval, the first timing interval being resettable in response to the signal;
an audible alert electronic circuit for actuation by timeout of the first timing interval and for providing successively louder audible signals;
a second programmable interval timing electronic circuit for measuring a second timing interval, the second timing interval being resettable in response to the signal from the electronic telephone in order to prevent timeout of the second timing interval; and
a programmed telephone number dialing circuit for actuation by timeout of the second timing interval, the audible alert electronic circuitry being activated to provide successively louder audible signals when the first timing interval has not been reset before timeout of the first timing interval, the programmed telephone number dialing circuitry being activated to dial at least one telephone number programmed therein when the second timing interval has not been reset before timeout of the second timing interval.

5. The inactivity alarm according to claim 4, wherein the selected mode of user actuation comprises a specified key/button press sequence.

6. The inactivity alarm according to claim 4, wherein the telephone comprises a cellular telephone.

7. The inactivity alarm according to claim 4, wherein the audible signals comprise a group of soft audible signals repeating over a predetermined time interval, the soft audible signals increasing in volume after expiration of the predetermined time interval.

8. The inactivity alarm according to claim 4, wherein the audible signals comprise beeps.

9. The inactivity alarm according to claim 4, wherein the programmed telephone number dialing circuit comprises means for re-dialing the programmed telephone number(s) for a predetermined number of rings every predetermined re-dialing time period.

10. The inactivity alarm according to claim 4, further comprising a GPS system activated in a coordinated manner with activation of the programmed telephone number dialing circuit.

11. An inactivity alarm, comprising:
a telephone service provider's electronic switch;
an inactivity timer programmed within the switch to time inactivity of the subscribers telephone line;
a notification database accessible to the switch, the notification database having at least one contact number stored therein for each subscriber; and
at least one recorded message accessible to the switch, the recorded message indicating inactivity of the subscriber; and
wherein when the inactivity timer has timed out, the switch dials the at least one contact number and plays the recorded message.
